(19) United States
(12) Patent Application Publication
(10) Pub. No.: US 2005/0218616 A1
(43) Pub. Date: Oct. 6, 2005

(54) Microscope storage system

(76) Inventors: David John Copeland, Milton, MA (US); Aidan John Petrie, Jamestown, RI (US); Ryan Patrick White, Georgetown, MA (US); Blaine Matthew Adams, Providence, RI (US); Alexander Arthur Newman, San Jose, CA (US); Robert J. Garay, San Jose, CA (US)

Correspondence Address: FISH & RICHARDSON P.C., PO BOX 1022, MINNEAPOLIS, MN, 55440-1022, US

(21) Appl. No.: 10/816,199

(22) Filed: Mar. 31, 2004

(51) Int. Cl. B62B 3/00

(52) U.S. Cl. 280/47.35

(57) ABSTRACT

Systems and techniques relating to a microscope storage unit. In one implementation, a storage unit includes a base, a top and multiple receptacles configured between the base and the top. Each receptacle is configured to house a microscope. The storage unit includes multiple charging devices, where each charging device is configured to recharge a battery of a battery-powered microscope. An electrical cord can be electrically connected to the multiple charging devices, and include a plug configured to mate with an electrical outlet to supply electrical power to the charging devices. One or more wheels can be connected to a lower surface of the base.

### BACKGROUND

The following description relates to a storage system for microscopes.

Microscopes are often used as a teaching tool in an educational environment. Students of all ages, including grade school through post-secondary institution students, may use microscopes in a classroom setting. Classrooms are often not suitably equipped with the necessary electrical outlets to power microscopes requiring an electrical power supply for illumination. For example, a classroom of twenty-four students may have considerably fewer electrical outlets, requiring students to take turns plugging in their microscopes. A classroom may have electrical outlets that are not within reach of each student's desk, requiring students to congregate with their microscopes near electrical outlets.

Cordless microscopes are available, including microscopes powered by a rechargeable battery. Some such cordless microscopes can be recharged by placing the microscope within a battery charging device, sometimes referred to as a docking station, that is designed to receive the microscope and recharge the battery. Alternatively, an electrical cord including an AC adapter can be plugged into the cordless microscope and into an electrical outlet to recharge the battery. In a classroom setting, similar problems can arise as discussed above in terms of a classroom being suitably equipped with enough electrical outlets, or conveniently positioned electrical outlets, to accommodate the number of battery charging devices required by the students in the class in order to recharge a set of the students' cordless microscopes.

### SUMMARY

Systems and techniques relating to a microscope storage unit. In general, in one aspect, the invention features an apparatus configured to house microscopes. The apparatus includes a base, a top and a plurality of receptacles configured between the base and the top. Each receptacle is configured to house a microscope. The apparatus further includes a plurality of charging devices. Each charging device is configured to recharge a battery of a battery-powered microscope and is positioned within one of the plurality of receptacles. An electrical cord is electrically connected to the plurality of charging devices, and includes a plug configured to mate with an electrical outlet to supply electrical power to the plurality of charging devices. One or more wheels are connected to a lower surface of the base.

Embodiments of the apparatus may include one or more of the following. The apparatus can further include a plurality of interior electrical receptacles electrically connected to the electrical cord. Each of the plurality of charging devices can include an AC adapter plugged into an interior electrical receptacle and electrically connected to a connector cord configured to electrically connect to a microscope. In another embodiment, each of the plurality of charging devices can be a docking station positioned within a receptacle.

The base and the top can be substantially rectangular in shape, and the apparatus can further include at least two sidewalls substantially perpendicular to the base and the top. The apparatus may include a plurality of exterior electrical receptacles, an exterior electrical receptacle configured to receive a plug attached to an electrical cord of a device for supplying electrical power to the device. The apparatus may include a cord retractor configured to retract and house the electrical cord, where the electrical cord is connected to the cord retractor and can be retracted into and at least partially housed within the cord retractor. One or more indicators can be included that are configured to indicate a charging status of a battery-powered microscope being recharged by a charging device. Each of the one or more indicators can include a light emitting diode. Each of the plurality of charging devices can be further configured to determine whether a rechargeable battery is substantially fully charged, and charge the rechargeable battery to substantially full capacity based on the determination.

The apparatus can include an AC adapter electrically coupled to the electrical cord and to the plurality of charging devices to adapt AC power to DC power. Alternatively, the apparatus can include a plurality of AC adapters electrically coupled to the electrical cord, where each AC adapter is electrically coupled to one of the plurality of charging devices.

Each of the plurality of receptacles can include an opening and at least four sidewalls defining an interior region for housing a microscope, the interior region accessible from the opening. The apparatus can include a movable sidewall that is substantially perpendicular to the base and the top, the movable sidewall movable between a first position wherein the openings of the plurality of receptacles are exposed and the corresponding interior regions are accessible and a second position wherein the openings of the plurality of receptacles are covered by the movable sidewall and the corresponding interior regions are inaccessible. Alternatively, the plurality of receptacles can be formed in a drawer positioned between the base and the top and slidable in a plane substantially parallel to the base and the top, wherein the drawer is slidable between an open position wherein the openings of the plurality of receptacles are exposed and the corresponding interior regions are accessible and a closed position wherein the openings of the plurality of receptacles are not exposed and the corresponding interior regions are inaccessible. In another alternative, the plurality of receptacles can be formed in drawer positioned between the base and the top, the drawer configured to pivot between an open position wherein openings of the plurality of receptacles are exposed and the corresponding interior regions are accessible and a closed position wherein the openings of the plurality of receptacles are not exposed and the corresponding interior regions are inaccessible.

In general, in another aspect, the invention features an apparatus including a base, a top and a plurality of receptacles configured between the base and the top, each receptacle configured to house a microscope. A plurality of electrical receptacles are included in the apparatus, an electrical receptacle configured to receive a plug attached to an electrical cord of a device for supplying electrical power to the device. An electrical cord is electrically connected to the plurality of electrical receptacles, the electrical cord including a plug configured to mate with an electrical outlet to supply electrical power to the plurality of electrical receptacles. One or more wheels are connected to a lower surface of the base.

Embodiments may realize one or more of the following advantages. An apparatus is provided that is configured to house multiple microscopes, for example, a set of microscopes to accommodate an entire classroom of students. The apparatus can be used as a storage unit when the microscopes are not in use, and includes one or more wheels so that the storage unit can be easily rolled into a convenient position when being used (e.g., the center of a classroom), and rolled out of the way when not in use. When not in use, the microscopes can be stored securely in a dust free, protected environment. The apparatus can provide an electrical power source to each of the microscopes housed within the apparatus, or to charging devices for rechargeable battery-powered microscopes housed within the apparatus, while using only one external electrical outlet. The requirement of only a single electrical outlet to power the apparatus can be useful in classrooms with limited electrical outlets or inconveniently located outlets. Battery-powered microscopes housed within the apparatus can be positioned into integrated charging devices (i.e., docking stations), so that when not in use, the battery can be recharged. A charging device can measure a charge in the microscope's battery and charge the battery to full capacity, without risk of overcharging. Conveniently positioned indicators, such as LEDs, can alert a user as to whether a microscope's battery is fully charged or in charging mode.

Details of one or more implementations are set forth in the accompanying drawings and the description below. Other features and advantages may be apparent from the description and drawings, and from the claims.

### DRAWING DESCRIPTIONS

These and other aspects will now be described in detail with reference to the following drawings.

FIG. 1A shows a cross-sectional view of a storage unit including charging devices.

FIG. 1B shows a side view of a storage unit with movable sidewalls in a closed position.

FIG. 1C shows an end view of a storage unit.

FIG. 1D shows a side view of a storage unit with movable sidewalls in an open position.

FIG. 1E shows a top view of a storage unit.

FIG. 2A is a side view of a storage unit including docking station type charging devices.

FIG. 2B is an enlarged view of a docking station type charging device from the storage unit of FIG. 2A.

FIG. 3A shows a highly schematic perspective interior view of a storage unit.

FIGS. 3B and C show a highly schematic perspective interior views of a receptacle formed within the storage unit of FIG. 3A.

FIG. 3D shows a cross-sectional end view of a storage unit.

FIGS. 4A-B are perspective views of a storage unit including pivotable drawers.

FIG. 5 is a perspective view of a storage unit including slidable drawers.

FIGS. 6A-B are perspective views of a storage unit including movable sidewalls.

FIG. 6C is a side view of a storage unit including movable sidewalls in a closed position.

FIG. 7 is a perspective view of a circular shaped storage unit.

Like reference symbols in the various drawings indicate like elements.

### DETAILED DESCRIPTION

The systems and techniques described herein relate to a system for storing microscopes.

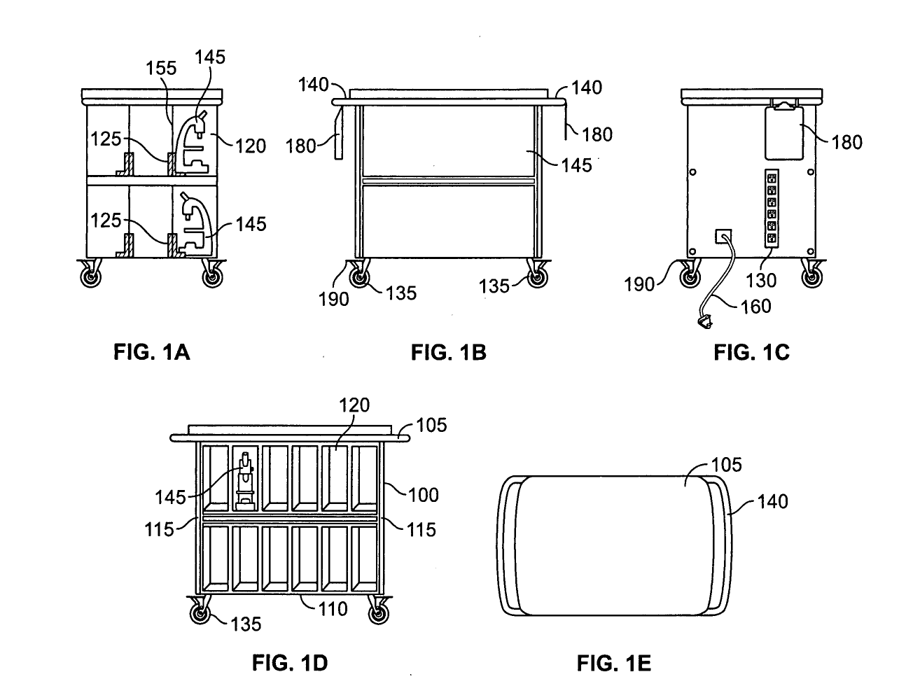

A microscope storage unit 100 is shown in FIGS. 1A-E. The storage unit 100 includes a top 105 that is substantially parallel to a base 110. The storage unit 100 can further include at least two substantially parallel sidewalls 115, that are substantially perpendicular to the top 105 and the base 110. One or more wheels 135 or other means for conveniently moving the storage unit 100 can be attached to the base 100. In the embodiment shown, a wheel 135 is attached near each of the four corners of the rectangular shaped base 100, although other configurations of the wheels 135 can be used.

Multiple receptacles 120 for housing microscopes, such as microscope 145, are formed between the top 105, base 110 and sidewalls 115. A receptacle 120 includes an interior region at least large enough to house a microscope, such as a microscope used in a classroom setting, e.g., Model M2250 available from Swift Instruments, Inc. of San Jose, Calif. The receptacle 120 can be enclosed on at least four sides, that is, the top, bottom and sides, to protect a microscope housed in the interior region. Optionally, the receptacle 120 can include a back panel, for example, a back panel formed from an interior wall 155 shown in FIG. 1A.

In the embodiment shown, the storage unit 100 includes two rows of six receptacles 120 formed on either side of the storage unit 100, for a total of twenty-four receptacles 120. Other configurations can be used, for example, to include more or less than two rows, or to include more or less than six receptacles per row. The receptacles 120 can be formed on two sides of the storage unit 100 as shown, or can be formed on one, three or four of the sides.

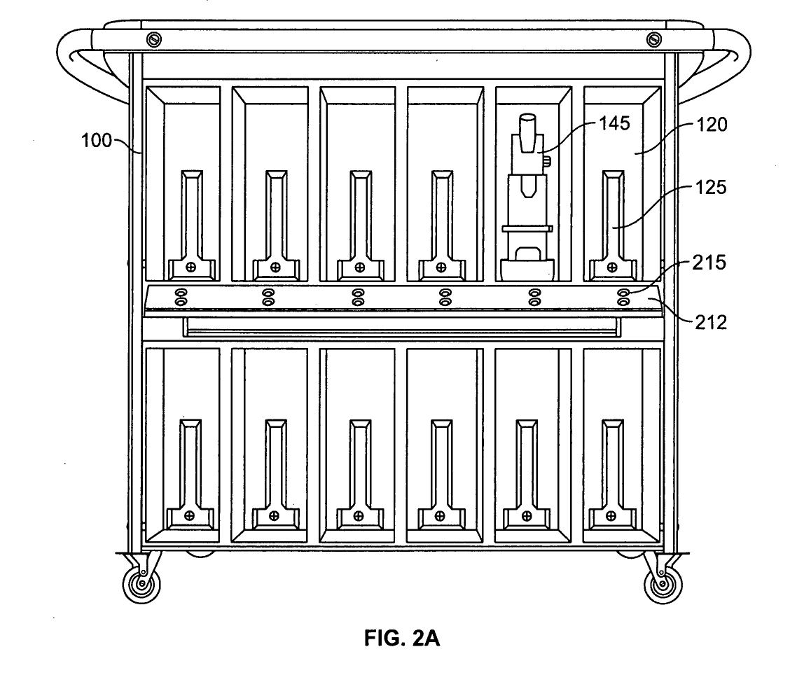

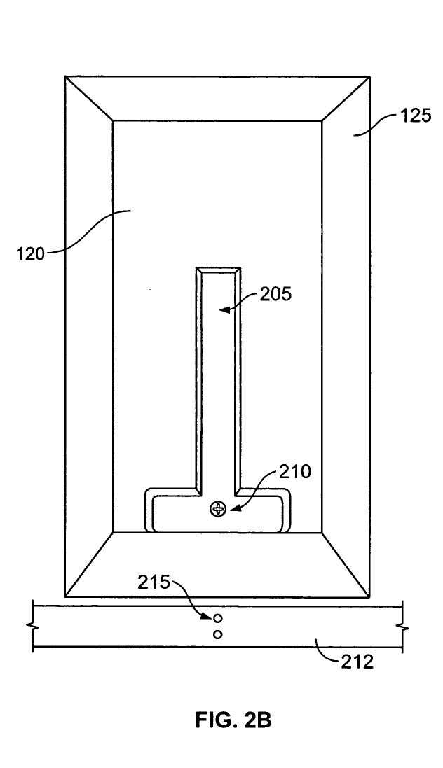

Referring to FIG. 2A, a receptacle 120 can include a charging device 125 that is configured to recharge a battery in battery-powered microscope. The charging device 125 can be positioned such that a microscope 145 housed within the receptacle 120 may be electrically connected to the charging device 125 to recharge the microscope's 145 battery.

In one embodiment, the charging device 125 is a “docking station” and is configured as shown in FIG. 2B. The docking station type charging device 125 includes a connector 210 adapted to mate with a corresponding connector formed on the microscope 145. The connector 210 can be a female connector, with a corresponding male connector included on the microscope 145, or alternatively can be a male connector, with a corresponding female connector included on the microscope 145. The charging device 125 can include a recessed area 205 that is configured to receive a portion of a microscope 145 to hold the microscope 145 in place during storage and while connected to the connector 210. A microscope 145 being placed into the receptacle 120 for storage and/or charging can be slid into the receptacle 120 to mate with the connector 210 and the recessed area 205 of the charging device 125.

Preferably the microscope 145 is positioned facing toward the back of the receptacle 120, so that a user can grip the microscope 145 by the support arm when moving the microscope 145 in and out of the receptacle 120, although receptacle 120 can be configured to receive a microscope 145 in another position. If positioned facing toward the back, then the portion of the microscope 145 received by the charging device 125 can be a front portion of the microscope base. If positioned facing toward the opening, then the portion of the microscope 145 received by the charging device 125 can be the support arm and/or a rear portion of the microscope base. Positioning the microscope 145 within the recessed area 205 prevents the microscope 145 from moving around during transport of the storage unit 100, further protecting the microscope 145 from damage.

In one embodiment, the charging device 125 can, upon connection to a microscope 145, determine the battery strength of the microscope's battery, for example, by measuring the charge in the battery, or a current flowing through a detection circuit that is connected to the battery. The charging device 125 recharges the battery in accordance with the determination, so as not to overcharge or undercharge the battery. In another embodiment, the charging device 125 can be time-based, meaning the level of charge in the battery is not measured, but rather the battery is recharged for a set period of time each time the battery is connected to the charging device 125.

The storage unit 100 can further include one or more indicators 215 that indicate the charge status of a microscope 145 connected to a charging device 125 within a receptacle 120. In one embodiment, the indicators 215 can be a pair of LEDs mounted on a panel 212 and positioned either above or below a receptacle 120. The LEDs are electrically connected to the charging device 125 in the corresponding receptacle 120. One LED can illuminate in green to indicate the battery of a microscope 145 connected to the charging device 125 in the corresponding receptacle 120 is fully charged, and the other LED can illuminate in red to indicate the battery is in the process of being charged, i.e, is not fully charged. Other types of indicators can be used, and the above described indicators are just one example.

A charging device 125 typically requires an AC adapter to adapt AC received from a power supply into DC required for the charging device 125. In one embodiment, the storage unit 100 can include a centralized AC adapter that can be electrically coupled to an external power supply and that is electrically coupled to each charging device 125 to provide electrical power to each charging device 125. For example, referring again to FIG. 1C, a centralized AC adapter (not shown) can be electrically coupled to an electrical cord 160 that can be plugged into an external electrical outlet to provide electricity to the charging devices 125. When the electrical cord 160 is plugged in, one or more of the charging devices 125 may be operable at the same time to recharge batteries of one or more microscopes 145 housed within the storage unit 100.

Alternatively, each charging device 125 can include an individual AC adapter that receives electrical power from an external source. The individual AC adapters can be electrically coupled to the electrical cord 160 that can be plugged into an external electrical outlet to provide AC to the AC adapters, which the AC adapters can then adapt to DC for each respective charging device 125.

Referring to FIG. 1C, in one embodiment, the storage unit 100 can include multiple exterior electrical receptacles 130 that are electrically connected to the electrical cord 160. When the electrical cord 160 is plugged into an external electrical outlet, the exterior electrical receptacles 130 can be used to provide electricity to a device, such as an electrically-powered microscope. For example, if microscopes 145 housed within the storage unit 100 require electrical power, then the storage unit 100 can be used to provide exterior electrical receptacles 130 into which the microscopes 145 can be plugged to provide electrical power to the microscopes 145. In the embodiment shown, the exterior electrical receptacles 130 are positioned on a sidewall 115. Other configurations are possible, for example, positioning the exterior electrical receptacles 130 on the top 105.

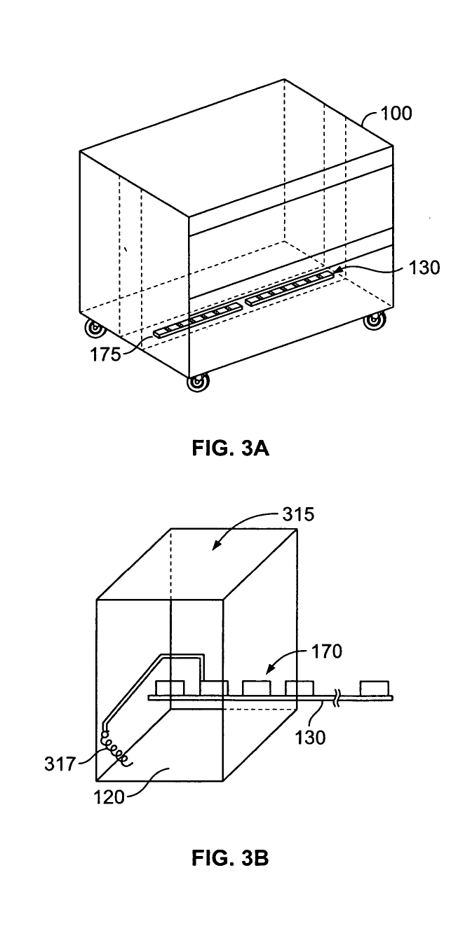

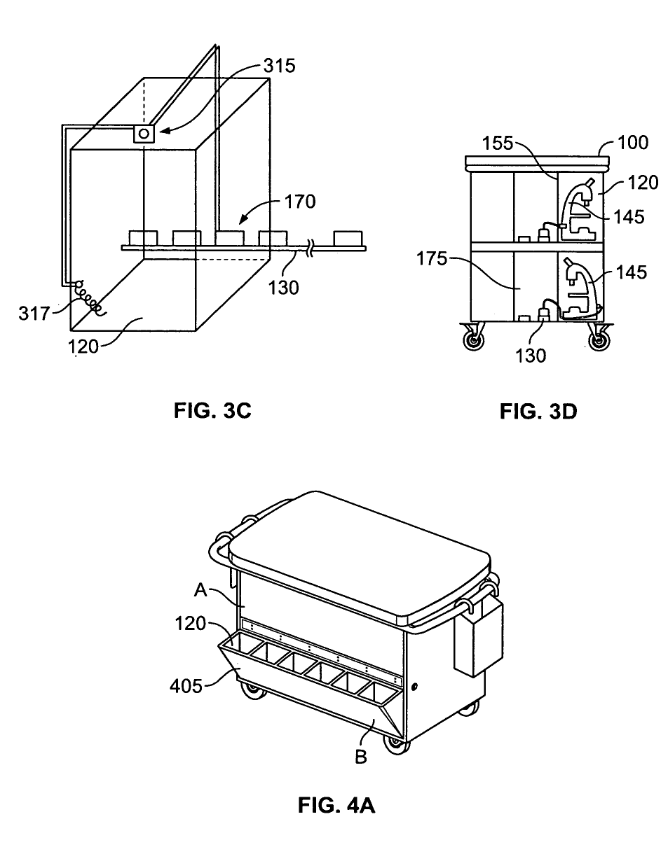

Referring to FIGS. 3A and D, in another embodiment, interior electrical receptacles 130 can be positioned inside the storage unit, for example, in an interior chamber 175 formed between the rows of receptacles 120 (not shown). The embodiment depicted does not include charging devices 125 as shown in FIG. 2A, but rather an AC adapter 170 for charging a battery in a battery-operated microscope 145 can be plugged into the microscope 145 and the interior electrical receptacle 130 to recharge the microscope's 145 battery. The interior electrical receptacles 130 can be, for example, two commercially available 24 inch power strips, including 12 electrical receptacles each, and which may include surge protection. Referring to FIGS. 3B and C, two different embodiments of a receptacle 120, with respect to the electrical circuitry for connecting an AC adapter 170 to a microscope 145, are shown.

In the embodiment shown in FIG. 3B, the AC adapter 170 is plugged into an electrical receptacle 130. The AC adapter 170 is electrically connected to an indicator 315, for example a pair of LEDs mounted on a panel that is similar to the panel 212 shown in FIG. 2A. The indicator 315 is electrically connected to a connector cord 317 mounted to an inside wall of the receptacle 120. The connector cord 317 is configured to mate with a connector formed in a microscope 145. The indicator 315 can provide a visual indication to a user as to whether a battery in the microscope 145 housed within the receptacle 120 and connected via the connector cord 317 to the AC adapter 170 is fully charged or not fully charged, e.g., a green light indicates fully charged and a red light indicates not fully charged. The indicator 315 can include circuitry that is configured to determine whether or not the battery is fully charged.

In the embodiment shown in FIG. 3C, the AC adapter 170 is electrically connected to the connector cord 317, and there is not an indicator 315 mounted on a panel. This embodiment may be preferable if the microscope 145 includes an indicator as to the battery strength of the microscope's battery.

Referring to FIG. 3D, in another embodiment, a second row of interior electrical receptacles 130 can be provided to service the upper row of receptacles 120. In another embodiment, a receptacle 120 can have an opening in the back panel 155 so that a user can insert any AC adapter into the electrical receptacle 130 and plug the other end of the AC adapter directly into the microscope 145 (i.e., without use of a connector cord 317). Alternatively, the electrical receptacle 130 can be positioned within the receptacle 120.

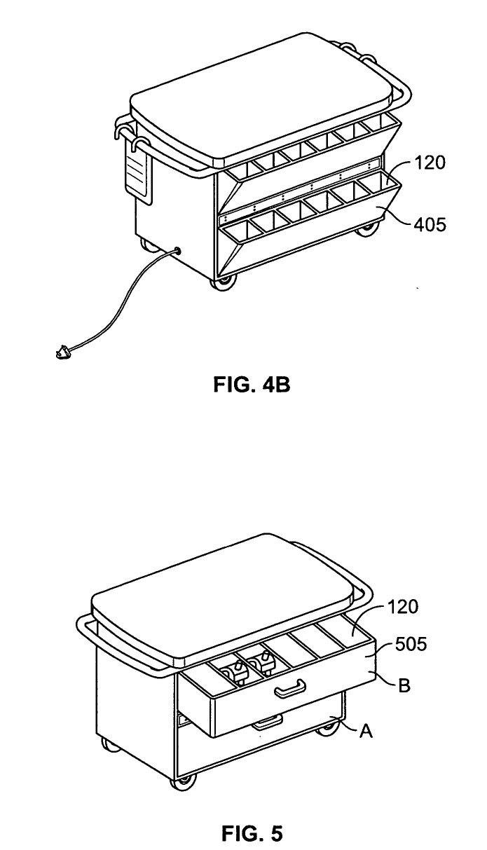

Referring to FIGS. 4A and 4B, in another embodiment, the receptacles 120 can be formed in a drawer 405 that can pivot between a closed position A into an open position B. In a closed position, the openings of the receptacles 120 formed in the drawer 405 are not exposed and the interior regions of the receptacles 120 are not accessible. In an open position, the openings of the receptacles 120 are exposed, and the interior regions are accessible, for example, to insert or remove a microscope. In another embodiment, each receptacle 120 can be formed in an individual drawer that can pivot between an open and closed position. Optionally, a drawer 405 can include a lock, so that in the closed position the drawer 405 can be locked to secure the contents of the receptacles 120.

Referring to FIG. 5, the receptacles 120 can be formed in a drawer 505 that is slidable between a closed position A and an open position B. In the closed position A, the openings of the receptacles formed in the drawer 505 are not exposed and the interior regions of the receptacles 120 are not accessible. In the open position B, the openings of the receptacles 120 are exposed and the interior regions are accessible. A microscope can be inserted into or removed from a receptacle 120 from an opening formed in the top of the receptacle when the drawer 505 is open. In another embodiment, each receptacle 120 can be formed in an individual drawer that can slide between an open and a closed position. Optionally, a drawer 505 can include a lock, so that in the closed position the drawer 505 can be locked to secure the contents of the receptacles 120.

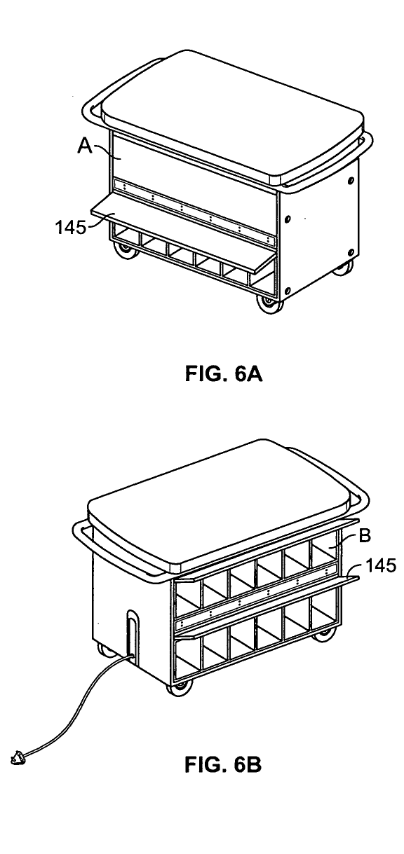

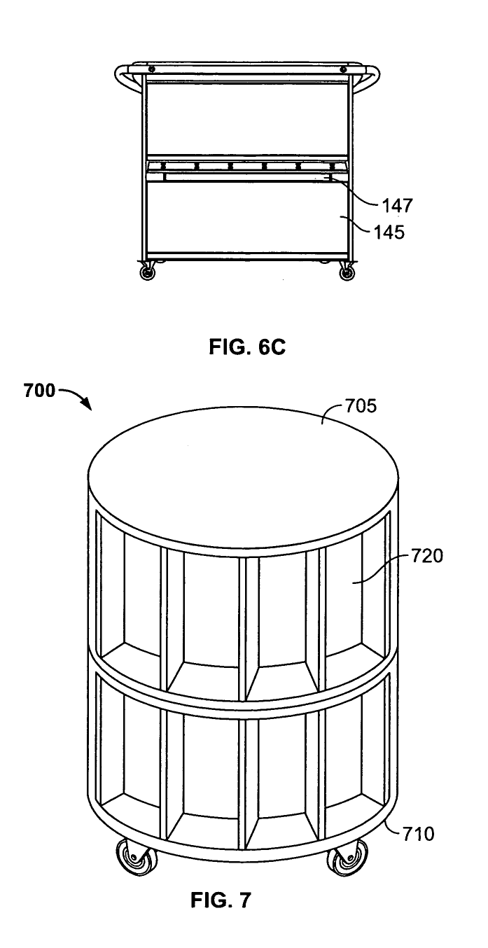

Referring to FIGS. 6A and 6B, in one embodiment the storage unit 100 can include one or more movable cover panels 145. A cover panel 145 can be moved into a closed position A to cover the openings of the receptacles 120 formed along a side of the storage unit 100, and moved into an open position B to expose the openings of the receptacles 120. The cover panel 145 can optionally include a lock so that in the closed position, the cover panel 145 can be locked to secure the contents of the receptacles 120. In the embodiment shown, a separate cover panel 145 is included for each row of receptacles 120. In another embodiment, a cover panel 145 can be configured to cover all of the receptacles 120 formed on a side of the storage unit 100, or alternatively, an individual cover panel can be included for each receptacle 120. The cover panels 145 in the depicted embodiment can be rotated upwardly and slid into the interior of the storage unit 100 when the panels 145 are in the open position. Referring to FIG. 6C, a slot 147 may be visible when the cover panel 145 is in the closed position, and the cover panel 145 can be slid into the slot 147 and housed within the storage unit 100 when the cover panel is in the open position. The cover panels 145 can be configured differently, for example, as hinged doors opening either upwardly, downwardly or to the side.

Referring again to FIG. 1E, in one embodiment, one or more rails 140 can be formed in, or attached to, the top 105. The rails 140 can be gripped by a user to facilitate pulling the storage unit 100 from one location to another. The rails 140 can also be used to support one or more hanging accessories, for example, a hanging clipboard 180 shown in FIG. 1C, or a hanging storage bin 185 shown in FIG. 1B.

Referring again to FIGS. 1B and 1C, in one embodiment, the wheels 135 can include locking mechanisms 190. A locking mechanism 190 can be switched between an unlocked position to move the storage unit 100 and a locked position when the storage unit 100 is desired to remain stationary.

In the embodiments depicted, the base 110 and the top 105 are rectangular in shape. However, in another embodiment, as shown in FIG. 7, the base 710 and top 705 can be circular, and the receptacles 720 can be formed around the perimeter of the circular shaped storage unit 700. In another embodiment, the base and top can be formed from shapes with any number of sides, for example, hexagons, to create a storage unit having a corresponding number of sides, and receptacles can be formed along one or more of the sides in a similar manner as depicted in the figures of a rectangular shaped storage unit 100.

In one implementation, the storage unit 100 can include a cord retractor configured to retract and house the electrical cord 160. The electrical cord can be connected to the cord retractor and can be retracted into, and at least partially housed, within the cord retractor. Conventional cord retractor mechanisms known in the art can be used. Typical cord retractor mechanisms include a spool around which the cord is wound, either manually, for example with a crank, or automatically by use of a spring loaded auto-retraction mechanism. For example, a cord retractor as described in U.S. patent application Ser. No. ______, filed ______ by Copeland, et al, entitled “Microscope with a Retractable Cord”, the entire contents of which are incorporated by reference, can be used.

The storage unit 100 can be made from a material that is durable to withstand classroom use, yet lightweight enough to allow easy transport. For example, the top 105, base 10 and sidewalls (if any) can be formed from steel, aluminum, ABS plastic, polypropylene, polyethylene, nylon or rubber. The receptacles 120 can be formed from the same material as the top 105, base 110 and sidewalls, or can be formed from a different material. In one embodiment, the receptacles 120 can be lined with a padded material, such as foam padding, to provide additional protection to the microscopes housed therein. The foam padding can optionally be form fitted to a particular model of microscope intended to be housed therein.

The storage unit 100 can be any convenient size, depending on the number of microscopes and size of the microscopes to be housed therein. In one embodiment, a storage unit 100 configured as shown in FIGS. 1A-E has a length, handle to handle, of approximately 52.5 inches, a width of approximately 32 inches and a height of approximately 42.75 inches.

Although only a few embodiments have been described in detail above, other modifications are possible. Other embodiments may be within the scope of the following claims.

1. An apparatus, comprising:
a base and a top;
a plurality of receptacles between the base and the top, each of the plurality of receptacles configured to house a microscope;
a plurality of charging devices, each of the plurality of charging devices configured to recharge a battery of a battery-powered microscope, where each of the plurality of charging devices is positioned within one of the plurality of receptacles;
an electrical cord electrically connected to the plurality of charging devices, the electrical cord including a plug configured to mate with an electrical outlet to supply electrical power to the plurality of charging devices; and
one or more wheels.

2. The apparatus of claim 1, further comprising a plurality of interior electrical receptacles electrically connected to the electrical cord, and wherein each of the plurality of charging devices comprise an AC adapter plugged into an interior electrical receptacle and electrically connected to a connector cord configured to electrically connect to a microscope.

3. The apparatus of claim 1, wherein each of the plurality of charging devices comprise a docking station positioned within a receptacle.

4. The apparatus of claim 1, wherein the base and the top are substantially rectangular in shape, the apparatus further comprising:
at least two sidewalls substantially perpendicular to the base and the top.

5. The apparatus of claim 1, further comprising:
a plurality of electrical receptacles, an electrical receptacle configured to receive a plug attached to an electrical cord of a device for supplying electrical power to the device.

6. The apparatus of claim 1, further comprising:
a cord retractor configured to retract and house the electrical cord, where the electrical cord is connected to the cord retractor and can be retracted into and at least partially housed within the cord retractor.

7. The apparatus of claim 1, further comprising:
one or more indicators configured to indicate a charging status of a battery-powered microscope being recharged by the charging device.

8. The apparatus of claim 7, wherein each of the one or more indicators comprise a light emitting diode.

9. The apparatus of claim 1, wherein each of the plurality of charging devices is further configured to:
determine whether a rechargeable battery is substantially fully charged; and
charge the rechargeable battery to substantially full capacity based on the determination.

10. The apparatus of claim 1, further comprising an AC adapter electrically coupled to the electrical cord and to the plurality of charging devices to adapt AC power to DC power.

11. The apparatus of claim 1, further comprising a plurality of AC adapters electrically coupled to the electrical cord, where each AC adapter is electrically coupled to one of the plurality of charging devices.

12. The apparatus of claim 1, wherein each of the plurality of receptacles comprises an opening and at least four sidewalls defining an interior region for housing a microscope, the interior region accessible from the opening.

13. The apparatus of claim 12, further comprising:
a movable sidewall that is substantially perpendicular to the base and the top, the movable sidewall movable between a first position wherein the openings of the plurality of receptacles are exposed and the corresponding interior regions are accessible and a second position wherein the openings of the plurality of receptacles are covered by the movable sidewall and the corresponding interior regions are inaccessible.

14. The apparatus of claim 12, wherein the plurality of receptacles are formed in a drawer positioned between the base and the top and slidable in a plane substantially parallel to the base and the top, wherein the drawer is slidable between an open position wherein the openings of the plurality of receptacles are exposed and the corresponding interior regions are accessible and a closed position wherein the openings of the plurality of receptacles are not exposed and the corresponding interior regions are inaccessible.

15. The apparatus of claim 12, wherein the plurality of receptacles are formed in drawer positioned between the base and the top, the drawer configured to pivot between an open position wherein openings of the plurality of receptacles are exposed and the corresponding interior regions are accessible and a closed position wherein the openings of the plurality of receptacles are not exposed and the corresponding interior regions are inaccessible.

16. An apparatus, comprising:
a base and a top;
a plurality of receptacles configured between the base and the top, each receptacle configured to house a microscope;
a plurality of electrical receptacles, an electrical receptacle configured to receive a plug attached to an electrical cord of a device for supplying electrical power to the device;
an electrical cord electrically connected to the plurality of electrical receptacles, the electrical cord including a plug configured to mate with an electrical outlet to supply electrical power to the plurality of electrical receptacles; and
one or more wheels connected to a lower surface of the base.

17. The apparatus of claim 16, further comprising:
a cord retractor configured to retract and house the electrical cord, where the electrical cord is connected to the cord retractor and can be retracted into and at least partially housed within the cord retractor.
